(19) United States
(12) Patent Application Publication
(10) Pub. No.: US 2021/0314172 A1
(43) Pub. Date: Oct. 7, 2021

(54) VALIDATING INTEGRITY OF PRIVATE KEYS FOR ON A DATA COMMUNICATIONS NETWORK USING BLOCKCHAIN KEY REGISTRY

(71) Applicant: Wivity Inc., San Francisco, CA (US)

(72) Inventors: Alfred Tom, San Francisco, CA (US); Jörg Brakensiek, Mountain View, CA (US); Kari Kostiainen, Zurich (CH)

(21) Appl. No.: 17/223,010

(22) Filed: Apr. 6, 2021

Related U.S. Application Data
(60) Provisional application No. 63/089,533, filed on Oct. 8, 2020.
(60) Provisional application No. 63/005,619, filed on Apr. 6, 2020.

(51) Int. Cl. H04L 9/32

(52) U.S. Cl. CPC H04L 9/3268; H04L 2209/38

(57) ABSTRACT

Block chain registries track the handling of private keys for validating the integrity of private keys for SSL certificates and other forms of private keys presented during transaction requests.

### CROSS-REFERENCE TO RELATED APPLICATIONS

This application claims priority under 35 USC 119(e) to U.S. Application No. 63/005,619, filed on Apr. 6, 2020 by Alfred Tom, et al. and entitled METHODS AND APPARATUS FOR A DISTRIBUTED DEVICE REGISTRY AND CYBERSECURITY DATA REPOSITORY and U.S. Application No. 63/089,533, filed on Oct. 8, 2020 by Alfred Tom, et al. and entitled VALIDATING INTEGRITY OF PRIVATE KEYS FOR SSL (SECURE SOCKET LAYER) CERTIFICATES ON A DATA COMMUNICATIONS NETWORK USING BLOCKCHAIN KEY REGISTRY, the content of both being incorporated herein by reference in their entireties.

### FIELD OF THE INVENTION

The invention relates generally to computer security, and more specifically, to validate the integrity of private keys for SSL certificates and other forms of private key based identity on a data communications network using block chain key registry.

### BACKGROUND

Existing computer network security infrastructure relying upon public/private key pairs are no more reliable than the integrity of the private key. For example, web page browsing and other Internet transactions rely upon the integrity of private keys in a public/private key pairs for network security. Private keys are presented to web browsers during web browsing on data communication networks using TSL connections for communication integrity and SSL certificates for device authentication. In another example, DER (distributed energy resources) devices are important for deriving clean energy from a distributed energy grid but are susceptible to attacks from malicious actors.

Problematically, CAs (Certificate Authorities) used to sign certificates based on private keys rely on both 1) the unforgeability of CA signatures, and 2) validation of the certification request. Conventional certificate validation techniques, such as CRLs (certificate revocation lists) and OCSP (online certificate status protocol), fail to provide adequate private key verification mechanisms which can lead to false positives with respect to authorization.

What is needed is a robust technique for validating the integrity of private keys for SSL certificates and other private key based digital identities on a data communications network using a blockchain key registry.

### SUMMARY

These shortcomings are addressed by the present disclosure of methods, computer program products, and systems for validating the integrity of private keys for authentication on a data communications network using a blockchain key registry.

In one embodiment, a network device (such as a network server) coupled to a data communication network performs a method for accessibility for programmatically verifying integrity of private keys associated with SSL certificates presented while handling transaction requests from network clients through blockchain repositories, the method comprising the steps of: connecting to a blockchain repository of immutable records or transactions stored with a consensus algorithm prior to the transaction in real-time, wherein the block chain repository tracks the how private keys are handled; responsive to a transaction request from a specific network client, determining whether a certificate associated with the transaction request is valid by using information in transactions on the blockchain; and validating the transaction request responsive to an authorization decision.

Advantageously, network performance is improved by reducing false positives with blockchain technology. Furthermore, one technology is used to improve another technology in that network security technology leverages blockchain technology.

### DETAILED DESCRIPTION

The description below provides methods, computer program products, and systems for validating the integrity of private keys for SSL certificates on a data communications network using blockchain key registry. One of ordinary skill in the art will recognize many additional variations made possible by the succinct description of techniques below. For example, alternative key pair systems to PKI and alternative verification systems to a CA can be implemented, given the principles of the disclosure herein.

### I. Systems for Validation of Private Keys

In one embodiment, a network security system validates the integrity of private keys for SSL certificates on a data communications network using a blockchain key registry. The network security system comprises a network server, a network client, and a blockchain registry. The components are each coupled to a data communication network, such as the Internet, a wide area network, a local access network, a cellular network, a Wi-Fi network, or a combination of network types. Many variations are possible (see Attachment B).

The network server, such as an HTTP server, stores a resource for access by network clients. The network server can store web pages, account information, databases, DER instructions (see Attachment C), and the like. Responsive to a request for resources, the network server contacts the blockchain key registry for validation information (e.g., of SSL certificates, crypto wallets, digital IDs, and other digital certificates). If the validation information is sufficient, the network server can approve the request for access and forward resources to the network client. On the other hand, if not sufficient, the network server can deny the request for access and block the resources from the network client. In other embodiments, additional factors may be considered for approval or denial, such as other validations, other network security systems (e.g., challenge/request system or intrusion detection systems), or network policies (e.g., time of day, nature of request, or access level of a user).

The network client can be a wireless station, an IoT (Internet of Things) device, a network appliance, a router, a firewall, a different network server, an access point, or any other network device acting as a requestor. Note that the client/server relationship can be relative and change based on which component is making a request.

The blockchain registry (or device security registry) can be a group of computers called upon to vote on the veracity of private key transactions based on immutable tracking of private key security information. Various consensus algorithms can determine a final determination of whether or not to validate private key security information. Different parties, such as auditors, manufacturers, and service providers, put information on the blockchain by proposing a blockchain transaction or record using various mechanisms like APIs (application program interfaces) and nodes. During a registration phase, the blockchain registry stores and updates records for assets that are called upon during real-time transactions (e.g., using x.509 extensions). A consensus algorithm is invoked when a new record is introduced to the blockchain for validation of the record before immutable recording in the blockchain registry. In one embodiment, the blockchain registry is controlled by a third-party entity independent of both the network server and the network client. The block chain registry is centralized for access by the network device and other components. In one implementation, the blockchain registry also maintains ownership records and transfers of ownership of private keys.

Each of the components can be implemented in hardware and/or software code on a computing device such as a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device. The computing device can comprise a processor, a transitory memory device, a non-transitory memory device, and an I/O port coupled for electronic communication via a bus. Communication can be digital and/or analog.

The processor can execute software processes based on code stored in memories. A hierarchy of software can include drivers to tie listed hardware components into a kernel of an operating system, and the operating system can include a shell as a platform for various software applications.

### II. Methods for Validating Private Keys

One embodiment of a method of network security validates the integrity of private keys for SSL certificates on a data communications network using a blockchain key registry. Responsive to a request for resources, the network server contacts the blockchain key registry for validation. The following steps represent general groupings of functionality and can be performed in different orders and the method can also contain additional steps.

In a first step, a blockchain key registry is configured and private key information is recorded, prior to any transactions. Periodic updates can occur as new keys are created and old keys are decommissioned. During a transaction, a network client can request resources from a network server by presenting a certificate. In response, the network server requests validation information related to the certificate from the blockchain key registry. The blockchain key registry collects information related to the certificate in the registry records and responds to the network server. In turn, the network server responds to the network client with an approval or denial of access. The resources may be subsequently provided to the network client, depending on the implementation.

### III. Additional Embodiments

Generally, one of ordinary skill in the art will recognize that the examples set forth herein are non-limiting and only illustrative of widely-applicable principles. Accordingly, this description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A computer-implemented method in a network device, communicatively coupled to a data communication, for accessibility for programmatically verifying integrity of private keys associated with SSL certificates presented while handling transaction requests from network clients through blockchain repositories, the method comprising the steps of:
connecting to a blockchain repository of immutable records or transactions stored with a consensus algorithm prior to the transaction in real-time, wherein the block chain repository tracks the how private keys are handled;
responsive to a transaction request from a specific network client, determining whether a certificate associated with the transaction request is valid by using information in transactions on the blockchain; and
validating the transaction request responsive to an authorization decision.
